(19) United States
(12) Patent Application Publication
(10) Pub. No.: US 2019/0020045 A1
(43) Pub. Date: Jan. 17, 2019

(54) REDOX FLOW BATTERY AND METHOD OF MEASURING STATE OF CHARGE THEREOF

(71) Applicant: OCI Company Ltd., Seoul (KR)

(72) Inventors: JaeMin KIM, Seongnam-si (KR); HeeChang YE, Seongnam-si (KR)

(73) Assignee: OCI Company Ltd., Seoul (KR)

(21) Appl. No.: 15/669,022

(22) Filed: Aug. 4, 2017

(30) Foreign Application Priority Data
Jul. 12, 2017 (KR) 10-2017-0088654

(51) Int. Cl. H01M 8/04537; H01M 8/18; H01M 8/04276

(52) U.S. Cl. CPC H01M 8/04641; H01M 8/188; H01M 2250/10; H01M 8/04582; H01M 8/04276

(57) ABSTRACT

Disclosed are a redox flow battery and a method of measuring a state of charge (SOC) thereof. The method may include measuring an open circuit voltage (OCV) during a specific period of time when a charging or discharging operation of a redox flow battery is performed, analyzing a change in SOC of the redox flow battery based on the measured OCV, correcting Coulomb efficiency based on the change in SOC, and calculating a second SOC of the redox flow battery based on the corrected Coulomb efficiency. The Coulomb efficiency may be a parameter, in which information regarding actual operation factors of the redox flow battery is contained.

### CROSS-REFERENCE TO RELATED APPLICATIONS

This U.S. non-provisional patent application claims priority under 35 U.S.C. § 119 to Korean Patent Application No. 10-2017-0088654, filed on Jul. 12, 2017, in the Korean Intellectual Property Office, the entire contents of which are hereby incorporated by reference.

### BACKGROUND OF THE INVENTION

The present disclosure relates to a redox flow battery and a method of measuring a state of charge (SOC) thereof, and in particular, to a method of measuring an SOC of a redox flow battery based on Coulomb efficiency.

With the recent serious shortage of electric power, introduction of natural energy such as wind power generation and solar power generation and stabilization of a power system have become a global issue. To address this issue, there is an increasing interest in large-capacity energy storage technology capable of increasing stability of output power and storing surplus power.

A redox flow battery is one of such large-capacity energy storage devices. The redox flow battery includes a cell that is configured to allow for conversion (i.e., charging and discharging) between chemical energy of electrolytic solution and electrical energy. The redox flow battery is advantageous for the purpose of stabilizing a power system in that it provides advantages such as large capacity, long life, and accurate monitoring of a charging state.

In order to prevent an over-charging or over-discharging problem from occurring in the battery, it is necessary to exactly measure a state of charge (SOC) of a redox flow battery.

### SUMMARY

Some embodiments of the inventive concept provide a method of measuring an SOC of a redox flow battery with high reliability and accuracy.

According to some embodiments of the inventive concept, a method of measuring a state of charge (SOC) of a redox flow battery may include measuring an open circuit voltage (OCV) during a specific period of time, when a charging or discharging operation of a redox flow battery is performed, analyzing a change in SOC of the redox flow battery based on the OCV measured during the specific period of time, correcting Coulomb efficiency based on the change in SOC, and calculating a second SOC of the redox flow battery based on the corrected Coulomb efficiency. The Coulomb efficiency may be a parameter, in which information regarding actual operation factors of the redox flow battery is contained.

According to some embodiments of the inventive concept, a redox flow battery may include a positive cell and a negative cell, a first storage tank configured to store a positive-type electrolytic solution and be in fluid communication with the positive cell, a second storage tank configured to store a negative-type electrolytic solution and be in fluid communication with the negative cell, an OCV measurement cell measuring a difference in electric potential between the positive-type and negative-type electrolytic solutions as an OCV, a Coulomb efficiency correction unit correcting Coulomb efficiency based on the OCV measured by the OCV measurement cell, and an SOC calculation unit calculating a second SOC based on the corrected Coulomb efficiency. The Coulomb efficiency may be a parameter, in which information regarding actual operation factors of the redox flow battery is contained.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 is a schematic diagram illustrating a cell of a redox flow battery according to some embodiments of the inventive concept.

FIG. 2 is a diagram schematically illustrating a redox flow battery according to some embodiments of the inventive concept.

FIG. 3 is a graph showing an actual SOC and an OCV-based SOC over time in a constant current charging operation of a redox flow battery.

FIG. 4 is a graph showing an actual SOC and an OCV-based SOC, when a flow rate of an electrolytic solution in a redox flow battery is high.

FIG. 5 is a graph showing an actual SOC and an OCV-based SOC, when a flow rate of an electrolytic solution in a redox flow battery is changed.

FIG. 6 is a flow chart illustrating a method of measuring an SOC of a redox flow battery system, according to some embodiments of the inventive concept.

FIG. 7 is a graph showing an actual SOC and an OCV-based SOC, when a redox flow battery is in a constant current charging period and an idle period.

FIG. 8 is a graph showing an actual SOC, an OCV-based SOC, and a SOC obtained based on a charge and Coulomb efficiency, when a redox flow battery is in a constant current charging period.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. For example, the relative thicknesses and positioning of molecules, layers, regions and/or structural elements may be reduced or exaggerated for clarity. The use of similar or identical reference numbers in the various drawings is intended to indicate the presence of a similar or identical element or feature.

### DETAILED DESCRIPTION

Example embodiments of the inventive concepts will now be described more fully with reference to the accompanying drawings, in which example embodiments are shown. Example embodiments of the inventive concepts may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

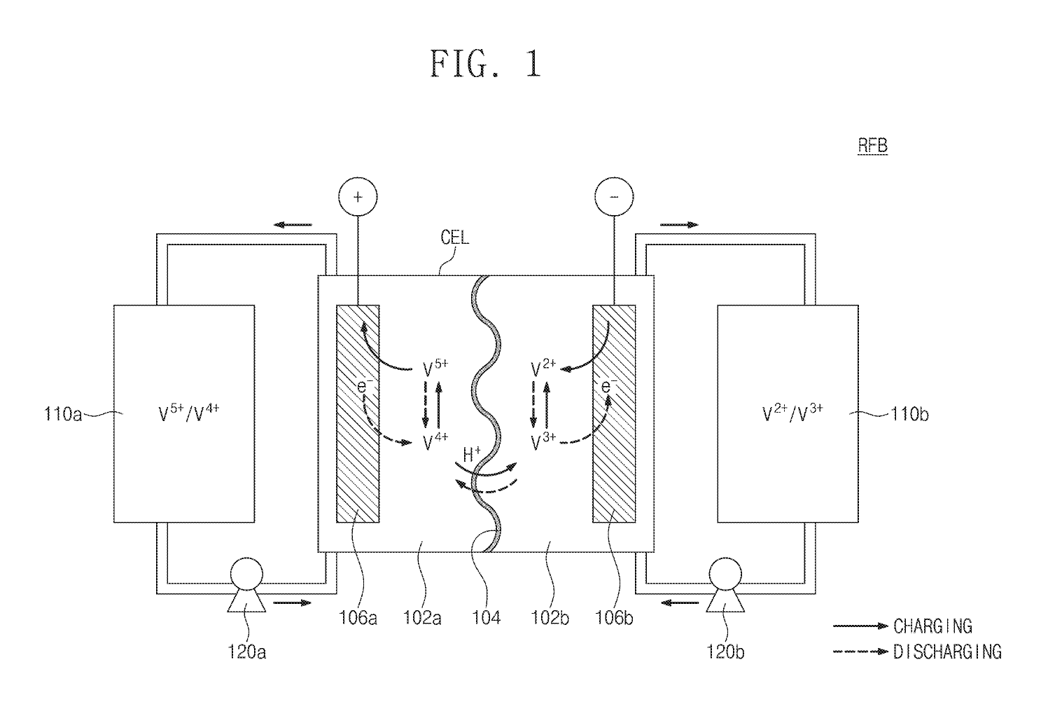

FIG. 1 is a schematic diagram illustrating a cell of a redox flow battery according to some embodiments of the inventive concept. Referring to FIG. 1, a cell CEL, a first storage tank 110a, a first pump 120a, a second storage tank 110b, and a second pump 120b may be provided.

The first storage tank 110a may be used to store a first electrolytic solution, and the second storage tank 110b may be used to store a second electrolytic solution. For example, the first electrolytic solution may be a positive-type electrolytic solution, and the second electrolytic solution may be a negative-type electrolytic solution. The first electrolytic solution may contain a vanadium active material such as V⁴⁺ ions and V⁵⁺ ions, and the second electrolytic solution may contain a vanadium active material such as V²⁺ ions and V³⁺ ions. Each of the first and second electrolytic solutions may further contain sulfuric acid, hydrochloric acid, or mixed acid thereof. The sulfuric or hydrochloric acid may be used to dissolve the vanadium active material.

The cell CEL may include a positive cell 102a, a negative cell 102b, a first electrode 106a in the positive cell 102a, a second electrode 106b in the negative cell 102b, and an ion exchange layer 104 interposed between the positive and negative cells 102a and 102b. As an example, the first electrode 106a may be a positive electrode, and the second electrode 106b may be a negative electrode.

Each of the first and second electrodes 106a and 106b may provide an active site for an oxidation-reduction reaction in the positive and negative cells 102a and 102b. For example, the first and second electrodes 106a and 106b may include non-woven fabric, carbon fiber, or carbon paper.

The first storage tank 110a may be in fluid communication with the positive cell 102a. In detail, the first electrolytic solution in the first storage tank 110a may be supplied into the positive cell 102a through the first pump 120a. When a charging or discharging operation is performed, electrons in the positive cell 102a may flow through the first electrode 106a. For example, during the charging operation, V⁵⁺ ions may be generated from V⁴⁺ ions, and electrons may be transferred to the first electrode 106a from the positive cell 102a (e.g., oxidation). During the discharging operation, V⁴⁺ ions may be generated from V⁵⁺ ions, and electrons may be transferred to the positive cell 102a from the first electrode 106a (e.g., reduction). If the oxidation-reduction reaction in the positive cell 102a is finished, the first electrolytic solution may be returned to the first storage tank 110a. The first pump 120a may be used to circulate the electrolytic solution between the first storage tank 110a and the positive cell 102a.

The second storage tank 110b may be in fluid communication with the negative cell 102b. In detail, the second electrolytic solution in the second storage tank 110b may be supplied into the negative cell 102b through the second pump 120b. When a charging or discharging operation is performed, electrons in the negative cell 102b may flow through the second electrode 106b. For example, during the charging operation, V²⁺ ions may be generated from V³⁺ ions, and electrons may be transferred to the negative cell 102b from the second electrode 106b (e.g., reduction). During the discharging operation, V³⁺ ions may be generated from V²⁺ ions, and electrons may be transferred to the second electrode 106b from the negative cell 102b (e.g., oxidation). If the oxidation-reduction reaction in the negative cell 102b is finished, the second electrolytic solution may be returned to the second storage tank 110b. The second pump 120b may be used to circulate the electrolytic solution between the second storage tank 110b and the negative cell 102b.

The positive cell 102a and the negative cell 102b may be separated from each other by the ion exchange layer 104. Nevertheless, the ion exchange layer 104 may be configured to allow for transportation of ions (i.e., cross-over) between the positive cell 102a and the negative cell 102b. For example, hydrogen ions (H⁺) may pass through the ion exchange layer 104 and may be transported between the positive cell 102a and the negative cell 102b. In addition, some of the vanadium active material ions V²⁺, V³⁺, V⁴⁺, and V⁵⁺ may also pass through the ion exchange layer 104.

According to some embodiments of the inventive concept, in the case where the redox flow battery is fully charged (i.e., SOC (state of charge)=100%), the vanadium active material in the first electrolytic solution may exist only in the form of V⁵⁺ ions, and the vanadium active material in the second electrolytic solution may exist only in the form of V²⁺ ions. According to some embodiments of the inventive concept, in the case where the redox flow battery is fully discharged (i.e., SOC=0%), the vanadium active material in the first electrolytic solution may exist only in the form of V⁴⁺ ions, and the vanadium active material in the second electrolytic solution may exist only in the form of V³⁺ ions. In the case where the redox flow battery is half charged (i.e., SOC=50%), the vanadium active material in the first electrolytic solution may contain V⁵⁺ ions and V⁴⁺ ions that are present in a ratio of 1:1, and the vanadium active material in the second electrolytic solution may contain V²⁺ ions and V³⁺ ions that are present in a ratio of 1:1.

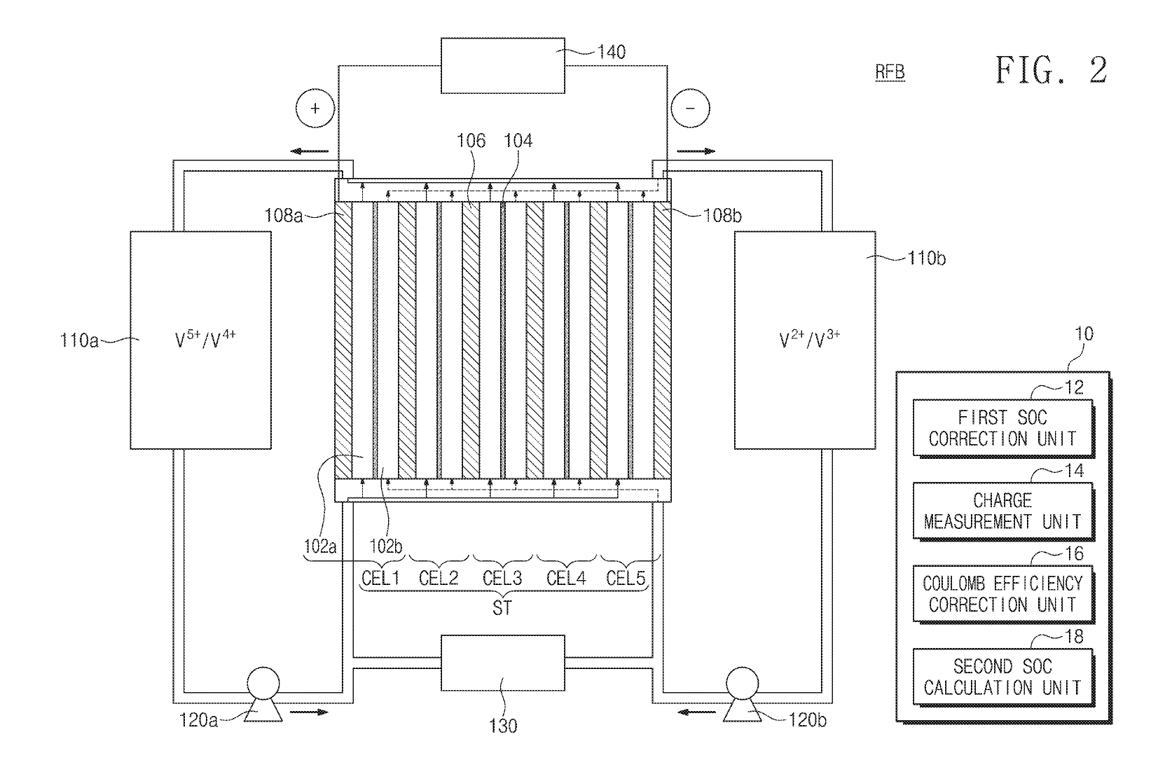

FIG. 2 is a diagram schematically illustrating a redox flow battery according to some embodiments of the inventive concept. Referring to FIG. 2, a redox flow battery RFB, according to some embodiments of the inventive concept, may include a stack ST, a first storage tank 110a, a first pump 120a, a second storage tank 110b, a second pump 120b, an open circuit voltage (OCV) measurement cell 130, a current measurement unit 140, and a controller 10. The stack ST may include a plurality of cells CEL1-CEL5. The stack ST may include, for example, first to fifth cells CEL1-CEL5. Each of the first to fifth cells CEL1-CEL5 may be configured to have substantially the same or similar features as those of the cell CEL previously described with reference to FIG. 1. As shown in FIG. 2, the first to fifth cells CEL1-CEL5 may be provided in the stack ST, but the inventive concept is not limited thereto. For example, the number and arrangement of cells in the stack ST may be variously changed by those skilled in the art.

In detail, each of the first to fifth cells CEL1-CEL5 may include an ion exchange layer 104. Bipolar electrodes 106 may be disposed between the first to fifth cells CEL1-CEL5. An adjacent pair of the cells may share a corresponding one of the bipolar electrodes 106.

For example, when viewed with reference to the first cell CEL1, the bipolar electrode 106 between the first and second cells CEL1 and CEL2 may correspond to the second electrode 106b previously described with reference to FIG. 1. When viewed with reference to the second cell CEL2, the bipolar electrode 106 between the first and second cells CEL1 and CEL2 may correspond to the first electrode 106a previously described with reference to FIG. 1. During the discharging of the redox flow battery, electrons may be transferred to the bipolar electrode 106 from a negative cell 102b of the first cell CEL1, and the electrons transferred to the bipolar electrode 106 may be transferred to a positive cell 102a of the second cell CEL2. During the charging of the redox flow battery, electrons may be transferred to the bipolar electrode 106 from the positive cell 102a of the second cell CEL2, and the electrons transferred to the bipolar electrode 106 may be transferred to the negative cell 102b of the first cell CEL1.

A first collection electrode 108a and a second collection electrode 108b may be provided at both ends of the stack ST. The first collection electrode 108a may be provided adjacent to the positive cell 102a of the first cell CEL1, and the second collection electrode 108b may be provided adjacent to the negative cell 102b of the fifth cell CEL5. As an example, the first collection electrode 108a may be a positive electrode, the second collection electrode 108b may be a negative electrode.

The first electrolytic solution may be supplied into the positive cells 102a of the first to fifth cells CEL1-CEL5 from the first storage tank 110a through the first pump 120a. The second electrolytic solution may be supplied into the negative cells 102b of the first to fifth cells CEL1-CEL5 from the second storage tank 110b through the second pump 120b. In some embodiments, all of the first to fifth cells CEL1-CEL5 in the stack ST may be configured to share the first electrolytic solution in the first storage tank 110a. All of the first to fifth cells CEL1-CEL5 in the stack ST may be configured to share the second electrolytic solution in the second storage tank 110b.

The OCV measurement cell 130 may be in fluid communication with the first storage tank 110a and the second storage tank 110b. The first electrolytic solution may be supplied into a first compartment of the OCV measurement cell 130 from the first storage tank 110a. The second electrolytic solution may be supplied into a second compartment of the OCV measurement cell 130 from \the second storage tank 110b. The OCV measurement cell 130 may be configured to measure an OCV based on a difference in electric potential between the first and second electrolytic solutions.

The current measurement unit 140 may be electrically connected to the first collection electrode 108a and the second collection electrode 108b. The current measurement unit 140 may be configured to measure a current, which may be produced during an operation of charging or discharging the redox flow battery RFB.

The controller 10 may include a first SOC correction unit 12, a charge measurement unit 14, a Coulomb efficiency correction unit 16, and a second SOC calculation unit 18. The first SOC correction unit 12 may be configured to correct an initial or first state-of-charge (SOC) to be the same value as a SOC which is measured based on an OCV during an idle period of the redox flow battery RFB. The charge measurement unit 14 may be configured to calculate a charge (an amount of electricity), based on current data that are measured by the current measurement unit 140 during the charging or discharging operation of the redox flow battery RFB. The Coulomb efficiency correction unit 16 may be configured to correct a predetermined value of Coulomb efficiency to be the same as a new value of Coulomb efficiency, which is calculated from an open circuit voltage (OCV) measured by the OCV measurement cell 130 during the charging or discharging operation of the redox flow battery RFB. The second SOC calculation unit 18 may be configured to calculate a present or second SOC, based on the first SOC, the charge, and the Coulomb efficiency value.

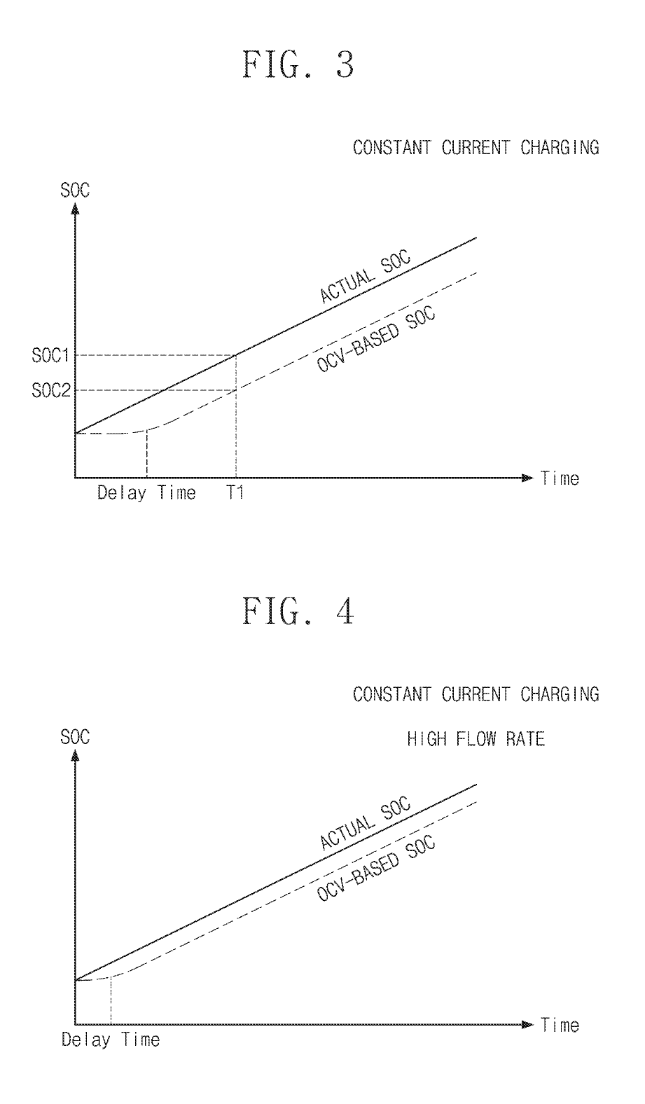

FIG. 3 is a graph showing an actual SOC and an OCV-based SOC over time in a constant current charging operation of a redox flow battery. Referring to FIGS. 2 and 3, in the case where the redox flow battery RFB is charged using a constant current, an actual SOC of the redox flow battery RFB may be linearly increased. As an example, an SOC of the redox flow battery RFB may be calculated from OCV data measured by the OCV measurement cell 130. For example, the Nernst equation, well known in the electrochemistry field, may be used to calculate the SOC from the OCV data.

In general, the open circuit voltage (OCV) may refer to a difference in electric potential between positive and negative electrodes when there is no current flow. Thus, for a typical secondary battery (e.g., a lithium battery), it is hard to measure the OCV during a charging or discharging operation. By contrast, in the case of the redox flow battery RFB, energy may be stored in the positive- and negative-type electrolytic solutions, not in an electrode material. Thus, even when the redox flow battery RFB is charged or discharged, it may be possible to measure a difference in electric potential between the positive- and negative-type electrolytic solutions using the OCV measurement cell 130, and thus, the OCV data may be obtained. That is, in the case of the redox flow battery RFB, it may be possible to monitor the OCV and OCV-based SOC properties in a real time manner, even during the charging or discharging operation.

As illustrated in FIG. 3, there may be a difference between an actual SOC and a measured OCV-based SOC of the redox flow battery RFB. For example, at a first time T1, the actual SOC and the OCV-based SOC may have different values (i.e., first and second values SOC1 and SOC2).

The OCV-based SOC may be delayed, when compared with the actual SOC. For example, it may take some time to transfer the first and second electrolytic solutions, which are in a charged or discharged state, from the stack ST of the redox flow battery RFB to the OCV measurement cell 130 through the first and second storage tanks 110a and 110b. As an example, in the case where capacity of the first electrolytic solution in the first storage tank 110a is 1,000 liters and a flow rate of the first electrolytic solution by the first pump 120a is 50 LPM (Liter per Minute), it may take 20 minute to circulate the first electrolytic solution through the stack ST.

As illustrated in FIG. 3, it may be some time, depicted by the delay time in FIG. 3, to transfer to the first electrolytic solution, which is in a charged state, from the stack ST to the OCV measurement cell 130, and, when measured from time when a constant current charging operation starts, such time was 20 minutes in the above example. As an example, the delay time may mean an amount of time taken to fully circulate the electrolytic solution through the storage tank and the stack. As another example, the delay time may mean an amount of time taken until a change profile of the OCV-based SOC becomes the same as that of the actual SOC. As described above, the delay time may be calculated from the capacity and the flow rate of the first electrolytic solution in the first storage tank 110a. However, actually, the delay time may be less than a value that is calculated from the capacity and the flow rate of the first electrolytic solution in the first storage tank 110a.

FIG. 4 is a graph showing an actual SOC and an OCV-based SOC, when a flow rate of an electrolytic solution in a redox flow battery is high. FIGS. 3 and 4 show that the delay time varies depending on a flow rate of an electrolytic solution. The flow rate of the electrolytic solution is higher in FIG. 4 than in FIG. 3, and the delay time is shorter in FIG. 4 than in FIG. 3. These results show that when flow rates of first and second electrolytic solutions in a redox flow battery are increased, the delay time is reduced.

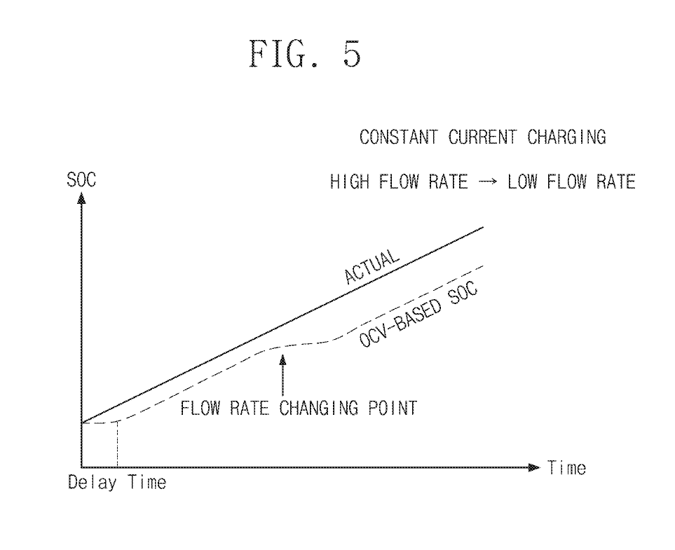

FIG. 5 is a graph showing an actual SOC and an OCV-based SOC, when a flow rate of an electrolytic solution in a redox flow battery is changed. Referring to FIGS. 3 and 5, when a redox flow battery is charged with a constant current, the actual SOC increases linearly over time, regardless of a change in flow rate of an electrolytic solution. However, the OCV-based SOC may be changed depending on the change in flow rate of the electrolytic solution, even during the constant current charging operation. This may be because the delay time does not vanish due to the change in flow rate of the electrolytic solution. That is, the use of the OCV-based SOC may lead to low accuracy and reliability. Thus, the use of the OCV-based SOC may increase a risk of an over-charging or over-discharging of a redox flow battery, when compared with the case where the actual SOC is used.

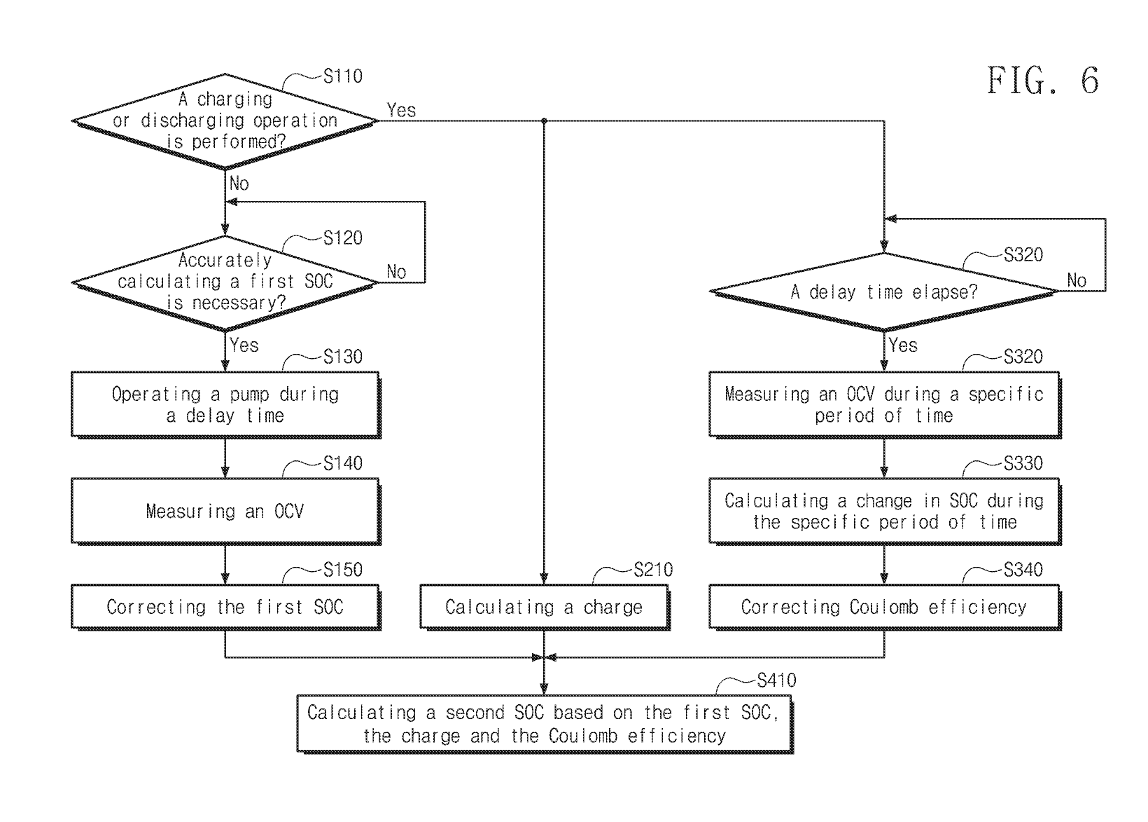

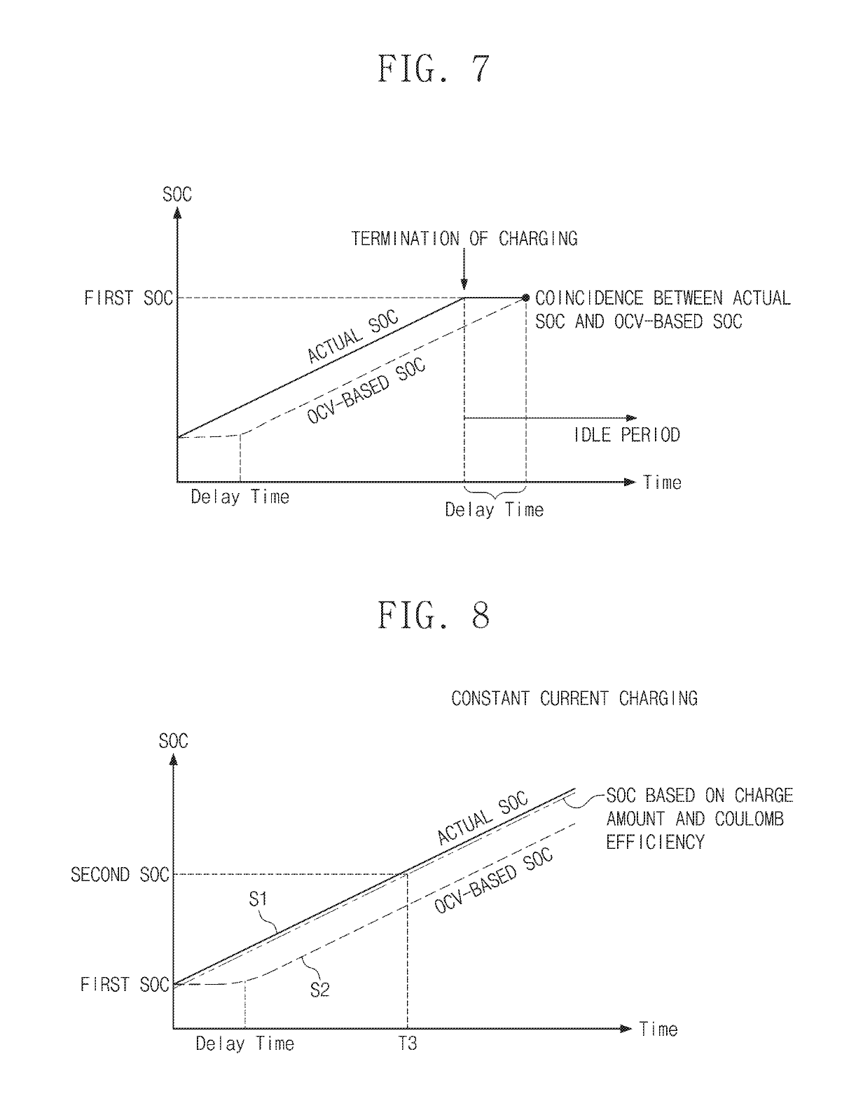

FIG. 6 is a flow chart illustrating a method of measuring an SOC of a redox flow battery system, according to some embodiments of the inventive concept. FIG. 7 is a graph showing an actual SOC and an OCV-based SOC, when a redox flow battery is in a constant current charging period and an idle period. Referring to FIGS. 2, 6, and 7, the actual SOC may be accurately measured, during an idle period of the redox flow battery RFB, in which the charging or discharging operation is not performed, and then, may be used to precisely correct an initial or first state-of-charge (SOC).

In detail, when a charging or discharging operation of the redox flow battery RFB is not performed (in S110) and it is necessary to accurately calculate a first SOC (in S120), the first pump 120a and the second pump 120b may be used to circulate the first and second electrolytic solutions (in S130). The first pump 120a and the second pump 120b may be operated during a delay time. As a result of the operation of the first pump 120a during the delay time, the first electrolytic solution in the redox flow battery RFB may have a substantially uniform composition. For example, the first pump 120a may be operated until the first electrolytic solutions in the first storage tank 110a, the stack ST, and the first compartment of the OCV measurement cell 130 have substantially the same composition. As a result of the operation of the second pump 120b during the delay time, the second electrolytic solution in the redox flow battery RFB may have a substantially uniform composition. For example, the second pump 120b may be operated until the second electrolytic solutions in the second storage tank 110b, the stack ST, and the second compartment of the OCV measurement cell 130 have substantially the same composition.

An OCV may be measured by the OCV measurement cell 130 (in S140). An actual SOC in the present state may be calculated from the measured data of OCV. Since the redox flow battery RFB is in the idle period and the first and second electrolytic solutions in the redox flow battery RFB have the uniform compositions, an OCV-based SOC to be obtained in the state may be the same as the actual SOC.

The OCV-based SOC may be set as a first SOC (in S150). That is, the first SOC may be corrected by the first SOC correction unit 12 of the controller 10 in such a way that the first SOC has the same value as that of the actual SOC.

Referring back to FIGS. 2 and 6, if the charging or discharging operation of the redox flow battery RFB starts to be performed, a current of the redox flow battery RFB may be measured by the current measurement unit 140. The charge measurement unit 14 of the controller 10 may calculate a charge from the measured current (in S210). For example, a charge during a charging or discharging operation may be obtained by integrating a current over time, as given by the following formula 1.

Charge=∫₀^{t}Adt [Formula 1]

The SOC of the redox flow battery RFB may be increased or decreased in proportion to an amount of charged or discharged charges. Other methods may be used to obtain the SOC of the redox flow battery RFB from a measured OCV. For example, the following formulas 2 and 3 may be used to calculate the SOC of the redox flow battery RFB. The following formula 2 may be applied to the redox flow battery RFB in the charging operation, and the following formula 3 may be applied to the redox flow battery RFB in the discharging operation.

$$\begin{matrix}Second SOC = First SOC + \frac{Charge}{Battery capacity} \times 100 \times Coulomb efficiency & [ Formula 2 ] \\ Second SOC = First SOC + \frac{Charge}{Battery capacity} \times 100 \div Coulomb efficiency & [ Formula 3 ]\end{matrix}$$

For example, let's consider a redox flow battery having Coulomb efficiency of 1, the total capacity of 1,000 Ah, and a first SOC of 25% (i.e., charged to 250 Ah). In the case where a charging operation is performed on the redox flow battery with a current of 100 A for 2 hours, we find, from the formula 2, that the present or second SOC is 45% (=25%+200 Ah/1,000 AH×100×1). If the formula 2 is used to calculate the second SOC, an error caused by a delay time may not occur, unlike the method of measuring an OCV and calculating an SOC. However, if the Coulomb efficiency is not accurately determined, there may be an error caused by the inaccuracy in Coulomb efficiency.

The Coulomb efficiency may be selected within a range from 0 to 1. The Coulomb efficiency may depend on various factors, such as cross-over between ions, a shunt current, temperature of electrolytic solution, SOC of a redox flow battery, a current density, and deterioration of an ion exchange layer. In other words, the Coulomb efficiency may be one of parameters, in which information regarding actual operations of the redox flow battery RFB is contained.

In an ideal case, the Coulomb efficiency may be 1, and this means that the charging or discharging operation can be performed without loss of charges. During the charging operation of the redox flow battery RFB, the Coulomb efficiency may be less than 1, and this means that an electrical energy supplied for the charging operation may be partially lost in the redox flow battery RFB and thus a portion of the electrical energy may not be converted to a chemical energy during the charging operation. By contrast, during the discharging operation of the redox flow battery RFB, the Coulomb efficiency may be less than 1, and this means that a chemical energy stored in the electrolytic solution may be partially lost in the redox flow battery RFB and thus a portion of the chemical energy may not be converted to an electrical energy during the discharging operation.

FIG. 8 is a graph showing an actual SOC, an OCV-based SOC, and a SOC obtained based on a charge and Coulomb efficiency, when a redox flow battery is in a constant current charging period. To calculate the second SOC using the above formula 2, Coulomb efficiency may be determined. Referring to FIG. 8, the Coulomb efficiency may be obtained from a slope S2 of the dotted line for the OCV-based SOC. Referring to the above formula 2, a slope S1 or S2 of the line for the SOC, in the graph of FIG. 8, may be

$$\frac{Current}{Battery capacity} \times 100 \times Coulomb efficiency$$

If the time elapsed from the start of the charging or discharging operation of the redox flow battery RFB exceeds the delay time (in S310), an OCV may be measured from the OCV measurement cell 130 during a specific period of time (in S320). A change in SOC during the specific period of time may be calculated from the measured data of the OCV (in S330). Meanwhile, as previously described with reference to FIG. 3, after the delay time, a change profile (or slope S1) of an actual SOC may be substantially the same as a change profile (or slope S2) of the OCV-based SOC. Thus, a change in the actual SOC may be calculated from the change in OCV during the specific period of time, and the Coulomb efficiency, in which information regarding various factors in actual operations is contained, may be determined or corrected on the basis of the change in the actual SOC (S340). For example, the Coulomb efficiency correction unit 16 of the controller 10 may be configured to correct a predetermined value of the Coulomb efficiency, based on data of the OCV measured during the specific period of time.

For example, in the case where the redox flow battery RFB having the total capacity of 1,000 Ah is being charged with a current of 100 A and a change in SOC for 1 hour measured through an OCV is 9%, the Coulomb efficiency may be 0.9.

Based on the first SOC corrected in step S150, the charge measured in step S210, and the Coulomb efficiency corrected in step S340, the second SOC may be calculated using the formula 2 (in S410). For example, the second SOC calculation unit 18 of the controller 10 may bring together all of the above-described information (e.g., on the first SOC, the charge, and the Coulomb efficiency) to calculate the second SOC.

For example, as described above, in the case where the Coulomb efficiency was 0.9, the first SOC was 25%, and the charging operation was performed for 2 hours with a current of 100 A, the second SOC calculated by the formula 2 may be 43% (=25%+200 Ah/1,000 AH×100×0.9).

In an SOC measuring method according to some embodiments of the inventive concept, it may be possible to prevent an error from occurring due to a delay time and a change in flow rate. In the SOC measuring method, it may be possible to accurately calculate a parameter (e.g., Coulomb efficiency) reflecting various factors in actual operations and thus to obtain SOC data with improved reliability and accuracy.

In a method of measuring an SOC of a redox flow battery according to some embodiments of the inventive concept, it may be possible to accurately calculate an OCV based on a parameter (e.g., Coulomb efficiency) that is determined in consideration of an actual factor in operations. Accordingly, an SOC of a redox flow battery can be calculated with high reliability and accuracy.

While example embodiments of the inventive concepts have been particularly shown and described, it will be understood by one of ordinary skill in the art that variations in form and detail may be made therein without departing from the spirit and scope of the attached claims.

What is claimed is:

1. A method of measuring a state of charge (SOC) of a redox flow battery, comprising:
measuring an open circuit voltage (OCV) during a specific period of time, when a charging or discharging operation of a redox flow battery is performed;
analyzing a change in SOC of the redox flow battery based on the OCV measured during the specific period of time;
correcting Coulomb efficiency based on the change in SOC; and
calculating a second SOC of the redox flow battery based on the corrected Coulomb efficiency,
wherein the Coulomb efficiency is a parameter, in which information regarding actual operation factors of the redox flow battery is contained.

2. The method of claim 1, further comprising:
circulating a positive-type electrolytic solution and a negative-type electrolytic solution of the redox flow battery, before the charging or discharging operation of the redox flow battery;
measuring an open circuit voltage (OCV) of the redox flow battery; and
correcting a first SOC based on the measured OCV,
wherein the second SOC is calculated based on the corrected first SOC.

3. The method of claim 2, wherein the circulating of the positive-type electrolytic solution and the negative-type electrolytic solution is performed until the positive-type electrolytic solution in the redox flow battery has a substantially uniform composition and the negative-type electrolytic solution in the redox flow battery has a substantially uniform composition.

4. The method of claim 1, further comprising measuring a charge during the charging or discharging operation of the redox flow battery,
wherein the second SOC is calculated based on the measured charge.

5. The method of claim 1, wherein the measuring of the OCV comprises measuring a difference in electric potential between the positive-type and negative-type electrolytic solutions in the redox flow battery.

6. The method of claim 1, wherein the measuring of the OCV is started after a predetermined delay time elapses from a start of the charging or discharging operation.

7. A redox flow battery, comprising:
a positive cell and a negative cell;
a first storage tank configured to store a positive-type electrolytic solution and be in fluid communication with the positive cell;
a second storage tank configured to store a negative-type electrolytic solution and be in fluid communication with the negative cell;
an OCV measurement cell measuring a difference in electric potential between the positive-type and negative-type electrolytic solutions as an OCV;
a Coulomb efficiency correction unit correcting Coulomb efficiency based on the OCV measured by the OCV measurement cell; and
an SOC calculation unit calculating a second SOC based on the corrected Coulomb efficiency,
wherein the Coulomb efficiency is a parameter, in which information regarding actual operation factors of the redox flow battery is contained.

8. The redox flow battery of claim 7, further comprising:
a first pump circulating the positive-type electrolytic solution between the positive cell and the first storage tank;
a second pump circulating the negative-type electrolytic solution between the negative cell and the second storage tank; and
an SOC correction unit correcting a first SOC during an idle period of the redox flow battery,
wherein the SOC calculation unit is used to calculate the second SOC based on the corrected first SOC.

9. The redox flow battery of claim 8, wherein, during the idle period, the first pump and the second pump are operated until the positive-type electrolytic solution in the redox flow battery has a substantially uniform composition and the negative-type electrolytic solution in the redox flow battery has a substantially uniform composition.

10. The redox flow battery of claim 7, further comprising:
a current measurement unit measuring a current of the redox flow battery; and
a charge measurement unit measuring a charge based on the measured current during a charging or discharging operation of the redox flow battery,
wherein the SOC calculation unit is used to calculate the second SOC based on the measured charge.
